(19) United States
(12) Patent Application Publication
(10) Pub. No.: US 2013/0323706 A1
(43) Pub. Date: Dec. 5, 2013

(54) Electronic performance management system for educational quality enhancement using time interactive presentation slides

(71) Applicants: Saad Ul Haq, London (GB); Israr Ul, London (GB)

(72) Inventors: Saad Ul Haq, London (GB); Israr Ul, London (GB)

(21) Appl. No.: 13/507,107

(22) Filed: Jun. 5, 2012

(51) Int. Cl. G09B 19/00

(52) U.S. Cl. 434/365

(57) ABSTRACT

This patent refers to a method of achieving greater quality assurance of teaching in classroom settings by the use of an electronic performance management system; the basis being modifying the use and nature of presentation slides. Essentially, this patent deals with timed presentation slides and interactive elements within these slides. Each slide is assigned an estimated duration and then compared with actual recorded duration; furthermore, certain words within the slide are made interactive. Based on this comparison and whether the interactive words are stimulated, the proposed software allows real-time monitoring of teaching variables such as coverage, depth, contact hours, etc.

This patent also incorporates predictions of these teaching variables at future times by extrapolation of teaching trends modelled on the use of timed slides and interactive elements. Also included is a method for the creation of timed slides and interactive elements by use of a toolbar alongside standard presentation software.

### BACKGROUND OF THE INVENTION

The need for quality control in teaching settings has always been a major concern for educators worldwide. This is required more than ever in today's teaching setting, as the number of students and courses, as well as the size of institutions has grown incredibly. The task of managing and evaluating each and every lecture and lecturer can be a daunting, laborious and highly subjective feat.

There are many problems currently faced in the quality control of teaching in institutions. Most, if not all, of the courses in a classroom setting in today's education system are taught using presentation programs (such as Microsoft PowerPoint) and thus this is the specific method of teaching this patent will entirely focus on. This widespread method of using presentations to impart education faces a dire need of quality control. Presentation programs have made teaching easier worldwide but questions arise, such as the fact that, at the moment, is there a foolproof, accurate yet unobtrusive way for analysing, identifying and managing the quality of education being imparted onto the students. Some of the issues that arise include, among others:
Lecture pace—is a lecturer spending too much time on an easy topic and not enough on a hard topic?
Lecturer attendance—have all lectures been attended?
Course depth—how much of course has been taught? How can it be objectively ascertained?
Time spent on individual slides—how much time should be spent on a slide? How can this be recorded and monitored effectively?
Identification of poor teaching quality; pace, depth, attendance, contact hours. Is the course being effectively taught? How can a lecturer be monitored unobtrusively?
Trends: will this course be completed on time at the current pace?
Effective and timely rectification of teaching problems: can a situation be rectified before irrevocable consequences, such as poor results and ratings?

As can be seen from the above issues, an effective time management system is crucial to achieve a better education system. Problems are realized at the end of the semester when students complain that the certain parts of the course were not taught to them even though the material was specified in the syllabus. Other ways in which these curriculum shortcomings come to light is when the majority of students perform poorly in examinations at the end of the term. So these findings coming to the attention of the faculty in-charge, deans or head of departments at the semesters end cannot be dealt with in time to rectify the bleak nature of the situation, and thus the students suffer as does the university itself due to a drop in their standards as they fail to provide a decent education to their students.

Conventionally, these problems are somewhat ineffectively managed in ways such as asking the lecturer teaching a particular course to submit a course portfolio at the end of the term, asking a lecturer or students about how much of a course has been covered, asking students about lecture delivery and depth of syllabus coverage, surveillance monitoring by the use of visual and/or audio systems, official inspectors sitting in classrooms/lecture halls, etc. However, each of these solutions are ineffective. In the cases of asking lecturers or students; the feedback is highly subjective, liable to many distortions and bias; intentional or otherwise. Surveillance is both cumbersome and obtrusive and the use of inspectors may hamper the concentration of some teachers.

### CONCLUSION

The answer to the above problems faced in increasing the quality of education exists around the presentation programs, more specifically, the slides themselves. The current methods of preventing the problems from occurring are still at a primitive stage as mentioned above. Ultimately there is actually no accurate and easily implementable method to monitor teaching through presentations.

The need for a real-time, objective and unbiased methodology to help achieve a better delivery of quality education for today's teaching practices that centre around presentation programs is of such paramount importance that without it the education delivery system will ultimately decrease significantly in quality. This methodology would aim to replace the current methods of quality control and performance enhancement so that any of the above mentioned discrepancies would be drastically diminished.

As the presentation program is the platform on which most teaching occurs, and it is through monitoring of it that quality in education will rise; the solution presented here will pertain to a method of creating and using presentations that contain timed interactive presentation slides and a system for logging, predicting, managing and rectifying in a teaching environment. The solution falls under an Electronic Performance Management System (EPMS) and it will take the form of software.

### BRIEF SUMMARY OF THE INVENTION

This invention will be used to achieve enhanced quality control of teaching in education enterprises such as universities with the creation and use of timed interactive presentation slides. The invention relates to a proposed method consisting of two phases. The first phase called the creation phase allows the first user, the creator, to create presentations that are ‘time-tagged’ and interactive using this software. This means that a unique individualized time period will be assigned to each slide on a given presentation on the basis of the expected time it would take to explain or teach it to a class of, for example, university students. Interactive elements would be created from the text matter of the slides by the user. This would be done using an input interface that fits into the presentation program window as a toolbar.

The second phase is known as the presentation phase in which a teacher in a teaching institution such as a university or college will use these time-tagged presentations to teach their respective courses. The software working in the background will record the actual time spent on each slide by the teacher, among other things such as the number of interactive elements stimulated, time of commencement of the presentation, etc. This data will be stored in archives in the institutions database. The software will access it to generate key performance indicators (KPIs) that will be displayed in report form in real-time to the concerned authorities in the institution, either over the internet or through networked devices. By this method, these KPIs, such as the estimated time of syllabus completion and depth of syllabus coverage, can be viewed by the authorities and if there is any discrepancy, it can be rectified with prompt action.

This method thus allows a quality control feedback loop to operate non-intrusively to monitor the teaching in a classroom setting with the simple use of timed interactive presentation slides.

### Advantages of the Proposed System

The main advantage of this method over existing conventional techniques is achieving quality control in institutions in a completely unobtrusive way. It does not disturb the lecturer or the students. In fact, lecturers themselves can use this software to learn to pace themselves while teaching. It allows lecturers to give accurately timed presentations. The software can be used to train teachers to take account of the time they spend per slide. Institutions can observe and evaluate the quality of teaching of their staff.

It allows institutions to evaluate teachers' teaching abilities confidentially without external inspectors having to come in. It will ensure a more unified and standardized teaching method without the mismanagement of time. The benefit of real-time evaluation by the software enables timely addressing of the problem and early rectification and ensuring the completion of the syllabus on time. This saves last minute stress for the lecturer and administrators, and complaints from the students. It will also allow in-depth syllabus coverage encouraging a more complete education delivery system by the use of interactive elements and the timed slides.

Potential Uses

Institutions looking to meet international quality standards and accreditation can use this software to expedite the process as it will raise their quality of teaching, making it transparent and fostering accountability among the lecturers.

This can be applied to many institutions by the government to ensure better education is available to every student throughout the country. If this method of education quality control is implemented, it will bring managing of teaching to a new level by tackling it from a fresh perspective. It will standardise classroom education. A sense of accountability will be cultivated in the lecturers without imposing too much force on them. And it'll be completely unobtrusive, as well as in real-time.

### DETAILS OF THE INVENTION

A proposed viable solution to the current problems can be easily visualised by the use of individually timed presentation slides. This simple and easily achievable solution is a method comprising the creation and use of timed interactive presentation slides. It consists of two discrete phases which are explained below:

The first phase consists of the creation of the timed interactive presentations and can be called the ‘creation phase’. This phase is done by the ‘first user’, which is an institution's syllabus creator, such as the head of department for a particular subject. This user can both create the presentations and assign time to them by using the ‘creator’ part of the software or just use any presentation already available and then assign the time to each slide. The creator part of the software is actually a plug-in that fits into a presentation program software window in the form of a toolbar allowing the first user, or creator, to assign ‘time-tags’ to the slides. These will be hidden tags within the slides (hidden from the second user), quantifying the expected time period for each slide in hours, minutes and seconds, based on the complexity of the slide, and according to the taggers judgement. This gives each slide a unique time period called the ‘expected time’. The reason for keeping the expected time of each slide hidden is to find out if the teacher can teach at the correct pace without knowing what the expected time is, i.e., are they able make a good judgement. If they can do that, it means they have good teaching ability. And the average time it takes to teach content on a slide varies only within a narrow range so the teachers will naturally not differ from the expected time, provided they teach properly. The second reason is that if the time is displayed on the slide, it will be very distracting and the aim of unobtrusiveness will be lost.

Time-tagging has to be done by a neutral person, i.e. not a lecturer (who will use the presentation to teach), who at the same time has enough knowledge of the subject matter of the presentations to assign a time to each individual slide based on their expectation of how long it would take a person to teach that slide. It would normally be a subject matter expert (SME) that is creating the presentation. Generally it may be a course supervisor at a university creating the presentations for the teaching faculty.

The creator has to be neutral in order to give credibility to the creation process because if the first user and the second user were one and the same person, or if one was partial to the other, cheating would take place and there would be no sense of authenticity of the evaluation while using these timed presentations. And he/she could assign any time they willed, for example a few seconds per slide, and teach accordingly, and take the rest of the day off and it would never show up on the quality control radar because simply they were doing nothing ‘wrong’ even if the times were absurd.

Once the presentations have been time-tagged, the creator may optionally now select a word from a selected slide(s) and make it a distinct interactive element. The purpose of this would be to make the presentation interactive and engaging and will help to prevent, to a certain degree, misuse of the software such as skipping through the slide material without actually teaching in detail and going through all the text. This makes the collected data more statistically accurate thereby ensuring the data's credibility.

These elements will be bold and italicised words from within the text of the slide requiring the presenter to encircle it, or underline it. A button will be present within the toolbar for this action during the creation phase.

This is the end of the creation phase.

The second phase is simply the use of these (now) readymade timed interactive presentations by the ‘second user’ who are essentially educators, such as university assistant professors, college teachers, etc. We shall generalise them and just call them ‘presenters’ and this phase shall be called the ‘presentation phase’. They will simply use these presentations and the ‘evaluator’ part of the software will be running in the background. This phase is completely unconnected to the first phase, and so are the two types of users, i.e. the creator and the presenter. This phase takes place at institutions wishing to achieve greater quality control of teaching by using this software. Note: the creator is not the user of the presentation for fear of biased results and loss of credibility, as mentioned before.

So in this phase, the concerned institution, for example a university, who wishes to adopt this new system to raise their teaching standards, or to assess their teachers for an upcoming accreditation from the ministry of education, or to implement a better nonintrusive system for monitoring what goes on in the classrooms, etc, would use the evaluator part of the software to evaluate the quality of teaching at their university.

This would be done by the use of this proposed method. Time-tagged presentations would be given to the teachers to teach from. In the classroom, the teacher would go through the presentation teaching each slide as he/she should, and all the while the software will be running in the background, evaluating unobtrusively. The device from where the presentation is running, i.e. the teachers laptop or the university pc etc, will be connected to the institution central server which will contain the software. The software will have its own database on this server, the significance of which is described later.

So when the timed presentation slides are used by the teacher, a number of lecture variables will be logged to create a report.

Stimulated here means interacted with. So each time the lecturer interacts with an interactive item, it is stimulated and that is logged by the software. The time-keeping for each slide is done by means of a timing device within the software. It can either use the software's built-in timer or work out the time from the clock of the device, e.g. laptop, which is playing the presentation. Thus raw data is recorded by the software during each lecture.

Naturally, a degree of freedom or variation of roughly 30% will be provided to compensate for different teaching styles of individual teachers. As some may be a little slower or some a little faster, but anything more than this set percentage variance will be counted as abnormal. This percentage can be based on statistics.

This method differs from conventional methods of timing presentations, like those that use countdown timers for slides or whole presentations by the fact that, unlike them, it will individualize each slide by assigning it an accurate time period, which will serve as a guideline as to how long that slide should be taught. It will also record the net time spent on each slide separately. For example, if the lecturer returns to a previous slide for a bit during the course of a lecture, time already spent on that slide plus this new time would be logged. It will not just simply countdown from the beginning of the presentation until the end. Or from the beginning of each slide till the presenter moves on.

As there are also interactive elements present throughout the presentation, the software will be able to estimate the depth of syllabus coverage. These will be easily identifiable by the lecturer as they will be bold and italic. When underlined or encircled, these interactive elements will be stimulated. The software will detect and record this interaction. By counting the number of elements stimulated, the software will be able to calculate depth of teaching using the logic that more the elements stimulated, more the elements encountered and interacted with, implying greater progression through the presentation and more detailed reading of the text on the slides. The lecturer will be briefed to strike-out or stimulate any interactive elements that appear throughout the presentation. This means the lecturer is not skipping material on the slide and is covering most if not all the slides in the lecture. And applying this method along with the time spent on each slide to several presentations can give a detailed idea of the amount of syllabus covered. Logically, it is recommended that the lecture should be presented on a smart-board, rather than the use of conventional projectors, making interaction with the interactive elements easy, but a laptop or pc may be alternatively used with the help of a mouse.

Reports and Databases

This invention relates to the creation of two types of reports; the Lecture Report and the Performance report, which will now be explained.
1. Lecture report: These will be generated automatically after each lecture, i.e. one report per lecture. Its purpose is to record the lecture variables and create a table of raw data. This report is not directly accessible, however, upon lecture completion it is accessible through the Archive Database which will be explained later. The recorded and calculated data fields (lecture variables) are:
   Time of commencing the presentation,
   Time of completion of the presentation,
   Amount of time taken to complete the presentation,
   Number of slides,
   Number of slides covered,
   Number of slides not covered and its percentage,
   Amount of time spent on each slide,
   Expected time to spend on each slide,
   Difference between the actual time and the expected time for each slide and its percentage,
   Number of interactive elements,
   Number of interactive elements stimulated,
   Number of interactive elements not stimulated and its percentage.
2. Performance report: This report is a straight-forward and concise overall review of a lecturer. It will be available to the concerned authorities in real-time. This report is essentially a final summary of all the lectures given (so far) by a particular lecturer in a form that can be primarily used by the authorities to monitor and judge a lecturer's performance in the courses being taught. Also present will be predictions/projections, warnings and possible routes of rectification. It may additionally be prepared and archived at set monthly intervals for possible future references. It will contain:
   Personal details (among others): name, ID, courses.
   Course details (per course):
      When started, when expected to finish, when predicted to finish, warning level (for instance—ranging from ‘No action required’ to ‘Urgent action required’).
      Percentage of course completed, expected percentage of course completion, prediction of amount of course completion at various milestones in the future, warning level.
      Graphs—showing average time with respect to expected time of completion of presentations and/or slides with lines indicating acceptable variations. Warning level.
      Number of contact hours, number of expected contact hours so far, warning level.
      Attendance—number of early leaves, late, sick leaves, not attending, attended. Permitted values alongside each. Warning level.
      Overall performance grade/number/scale/level/rank—based on the predictions made, a summarizing scale that enables a lecturer to be ‘graded’ and thus implies acceptable and non-acceptable ‘grades’. This is dynamic and may change according to lecturer performance.
      Rectification methods for each category above (for example—schedule extra classes to increase contact hours).

Once the lecture report has been created, it is archived in a database called the Archive Database, which will be explained below.
Archive database: This database is a hierarchical and categorized raw data archive. The source of raw data being the lecture reports—every lecture by all lecturers. The purpose of this database is for the detailed review of each lecture or lecturer and it is available at all times but updated after every lecture. the archive will be categorized by either lecture or lecturer.

There are other databases from which the proposed system may gather data to make certain prediction, which will be discussed later. For instance, records on lecturer attendance, lists of courses assigned to each lecturer and other such records pertaining to courses, lecturers and the institution in general that could possibly help in evaluating a lecturer from a variety of data.

Backend Working of the Software

Mentioned earlier was the fact that the software is present on the central server of the institution to which all devices that are used for teaching purposes in the classroom are connected and that the software will also have access to a database; Archive Database, specific to the institution that is also present on the central server. The software on the institute's central server may either be installed on the server or used as a cloud application over the internet.

A method to uniquely identify which lecturer is currently using the software, i.e. giving a lecture, can be a simple user-name and password system.

Prediction and Extrapolation

There is a dual importance of the Archive Database and the other institute databases (pertaining to the lecturer, such as courses assigned, etc.). In the case of the Archive Database, one is for keeping a backup of all the raw data produced and logged during each lecture. And the second, more important, one is for the software to use various types of predictive algorithms to make various real-time predictions regarding lecturer performance (these predictions appear in the Performance Report).

It does this by analysing the current lecture variables logged or being logged (if the lecture is running at that moment). Working on the basis of Artificial Neural Networks (ANNs), it will predict whether the syllabus given to a particular lecturer to teach will be covered in the given time and how much will be completed by a certain time(s). This ANN works in a non-linear and parallel fashion combining multiple inputs to produce an output. It will analyse this continuous stream of input and produce real time dynamic predictions. The advantage of these predictive algorithms is that they are able to learn from previous inputs and accordingly estimate the future outcome with great accuracy.

Below is a list of a few possible scenarios involving predictions and rectification on a lecturer's performance that this proposed system can generate, however, it must be noted that the predictive algorithms will analyse many more inputs to predict and thus the best possible method of rectification will be chosen. The methods of rectification below are just possible methods as we have not considered the lecture reports and other data already held on the lecturer by the institute and thus we cannot circle the true reason for the problem.
Will finish course too late or has not covered adequate amount of course syllabus or will not be able to cover adequate amount of course syllabus: schedule extra/longer classes, spend less time per slide/presentation, increase attendance.
Will finish course too early: spend more time per slide/presentation.
Not enough contact hours: Schedule extra/longer classes, spend more time per slide/presentation, increase attendance.
Not adequate course depth: increase time per slide/presentation, schedule extra/longer classes, increase attendance.

### FURTHER USES AND ADVANTAGES

1. Lecturer training—train and help new teachers get accustomed to the correct pace and length of teaching using presentations, aid teachers refine their way of teaching and self-assessment.
2. Accreditation—aid in this process by providing a novel means of objectively attaining performance levels of teachers and institutions in the form of historical reports and statistics.
3. Providing a standardized foundation for the use of computer presentations as a primary/more-significant means of teaching that previously did not exist.
4. Educational instruction research—help to further understand teaching trends and methodology for increased quality of education.

This invention will now be described solely by way of example and with reference to the accompanying drawings in which:

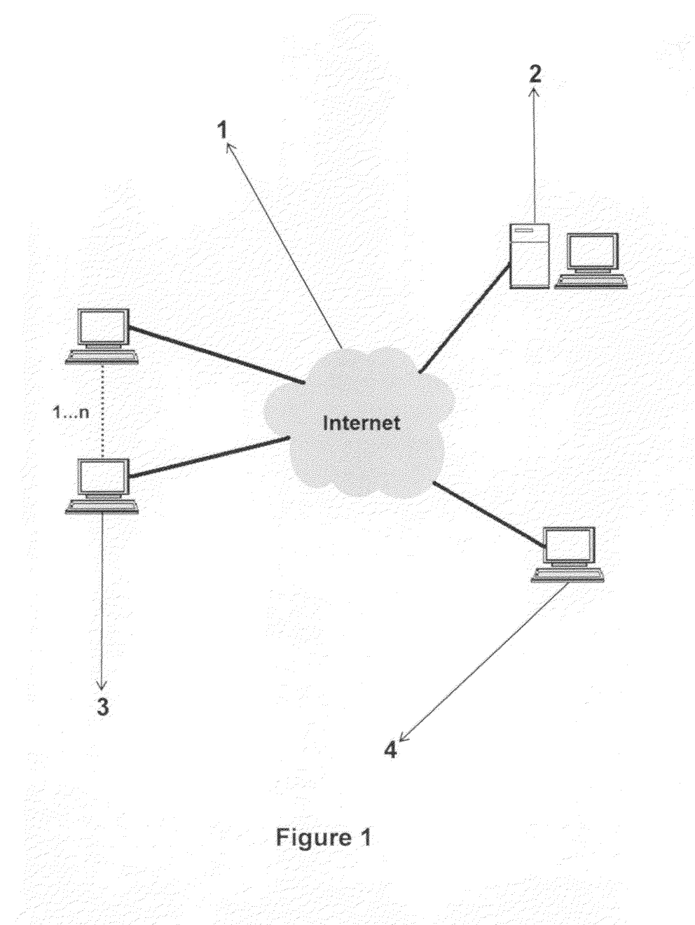

FIG. 1 shows a possible layout of the network structure that can be used to effectively run the proposed software invention, where the software will be used as a cloud application and all computer terminals and servers of the institute are networked over the internet,

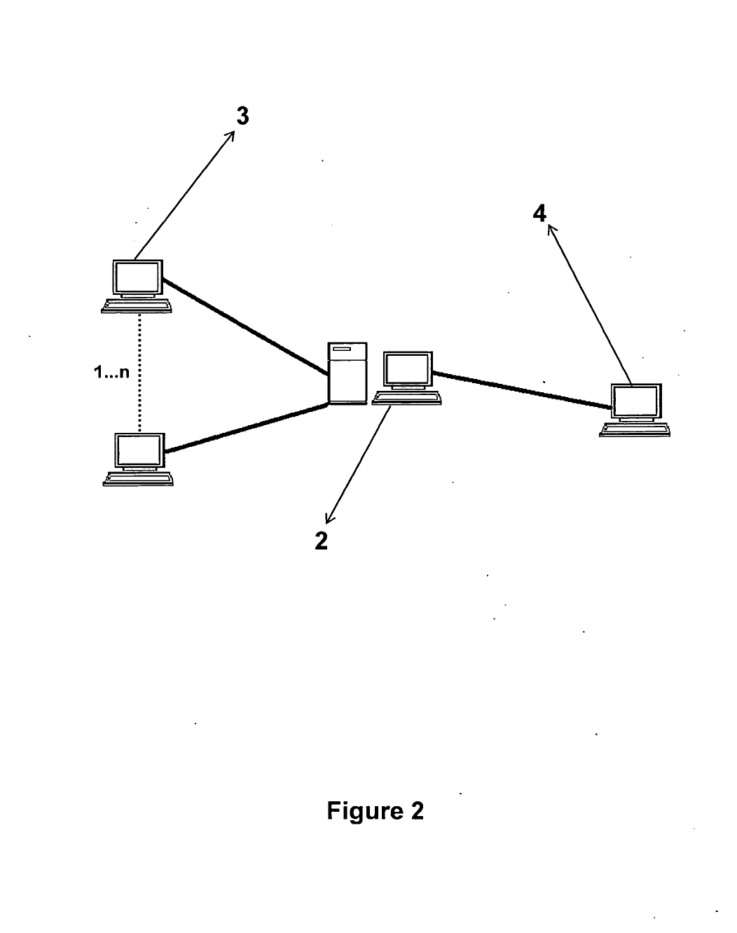

FIG. 2 shows another possible layout of the network structure wherein the proposed software is similarly installed on the institute's central server but all networking is LAN/WAN based as opposed to internet based,

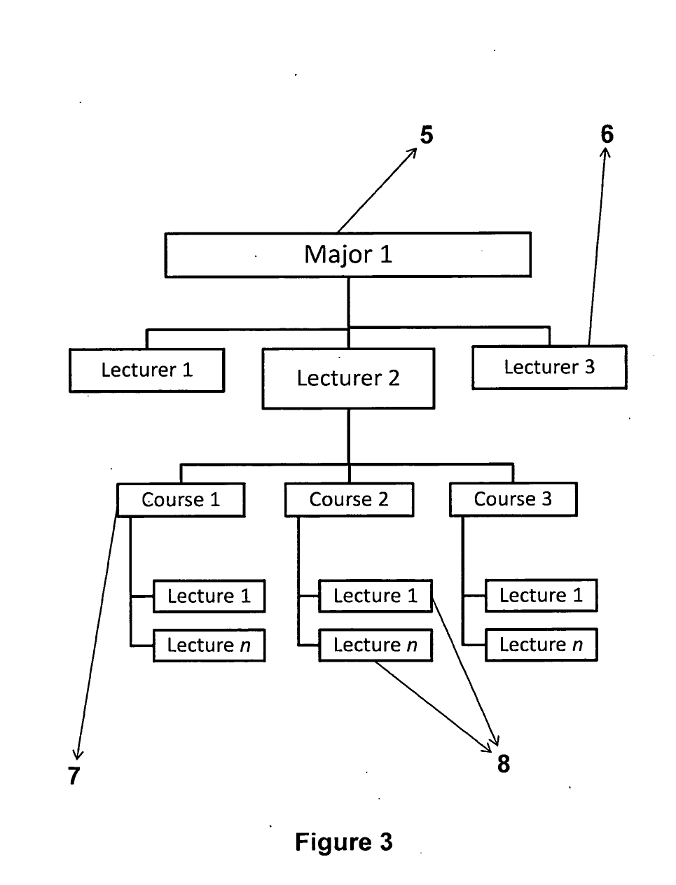

FIG. 3 shows the basic hierarchical structure of the institute's Archive Database,

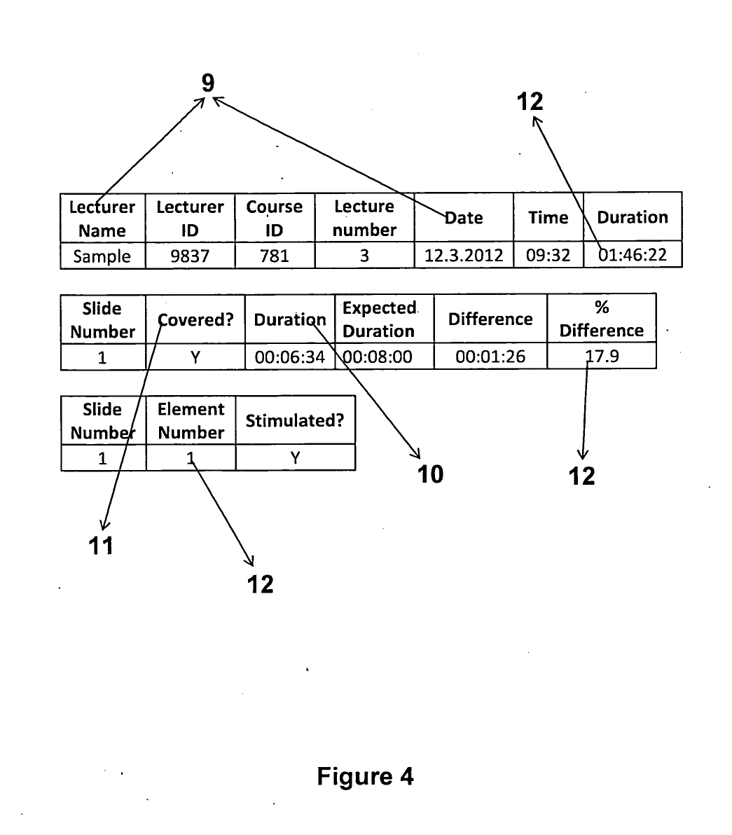

FIG. 4 shows a dummy lecture report with all the essential fields for the proposed invention to log and use the data collected over the course of each lecture,

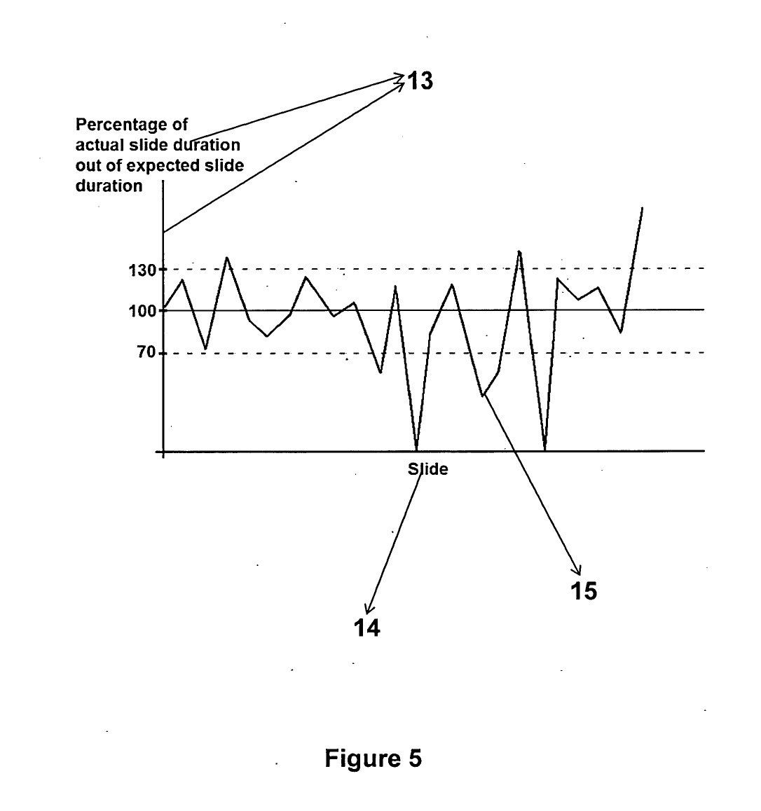

FIG. 5 shows an example of the type of graph that can be generated and presented for analysis in a performance report, wherein this particular graph concerns one particular lecture,

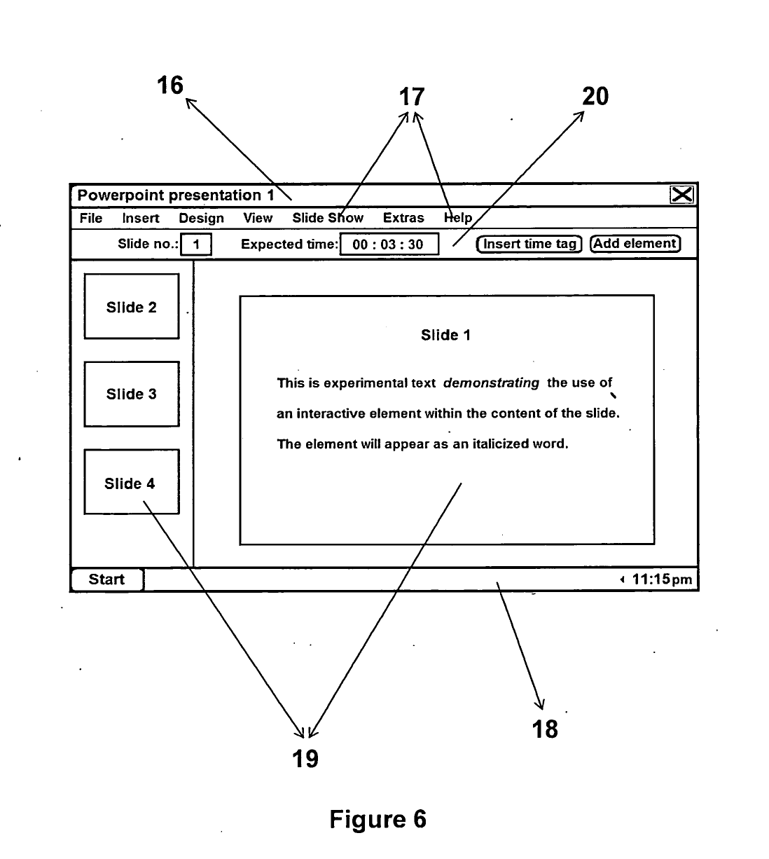

FIG. 6 shows the basic concept of the type of interface that the user assigning the slide time tags will use, consisting of essentially any presentation software such as Microsoft PowerPoint and an integrated toolbar to assign the time tags and interactive elements,

FIG. 1 shows a type of network architecture in which the institute terminals belonging to the authorities (4), such as the principal and head-of-department, are connected to the institutes central server (2) by means of the internet (1). Also connected to the central server (1), are the lecture room terminals (3) which are the computer terminals the lecturer/teacher will use to log on and teach using the proposed software. The main point of this figure is the use of the internet as the means of linking up the various terminals at the institute. An advantage of this is that a basic internet connection can be used to access and use the software by any device (smart phone, tablet, laptop, etc.) to teach.

FIG. 2 shows another type of network architecture that can be used. The difference here is that all the terminals are linked as LAN/WAN directly to the institute's central server (2). A disadvantage of this may be that the authorities cannot access the database (for reports, etc.) from a different location offsite such as their home which otherwise would have been possible using the network in FIG. 1.

The lecture room terminal (3) is the terminal the lecturer will use to teach, the variables will be recorded and logged in the central server (2). The authorities can then view this along with other data from their respective terminals (4).

FIG. 3 shows the hierarchical structure of the section of the institute's Archive Database that is used to log lecture reports. The first level of the database (5) in this case begins with the major; however it may alternatively be rearranged by lecturer or by course. The second level (6) shows every lecturer that is teaching that particular course: The third level (7) shows all the courses of that particular major that the chosen lecturer is/has taught. And finally, the last level (8) shows all the lectures that have been given (for the chosen major, lecturer and course). Each lecture's lecture report can then be accessed for whatever reason required.

FIG. 4 shows a sample of a dummy lecture report with all the essential fields. These essential fields can be principally divided into fields concerning: personal and general details (9), time tags (10) and the interactive elements (11). The dummy data (12) has only been given to give an idea of the type and format of the data concerning each field, it is not descriptive text of any sort.

Practically, there may be additional fields not covered here, but those given give a general idea for use in the proposed performance management system.

FIG. 5 shows just one type of graph that may be included for analysis in the performance report. This particular graph is an analysis of a particular lecture; the point of each trough and crest represents a single slide, an example of a particular slide is given by the trough tip (15). The horizontal axis (14) represents the slide number and the vertical axis (13) represents the actual duration of a slide compared with its expected duration (as a percentage), meaning that if a certain slide is expected to take a minute to teach and it actually took thirty seconds, this slide will take the value of 50 on the vertical axis and likewise it would be 100 if it took a minute. Building on this point, we may assign limit on either side of the expected duration for each slide to account for a natural variation. A variation of 30% has been indicated with respect to 100% by the dotted and whole line respectively. The trough tip (15) mentioned earlier as an example also shows just one example of a slide that has gone beyond the lower limit and will thus be flagged as unacceptable. Furthermore, the two troughs that touch the horizontal axis indicate no time spent teaching these slides, meaning they were skipped and thus are also flagged. This figure can also be adjusted so that instead of looking at one lecture (a number of slides) we may look at a number of lectures (i.e. a semester or course). So that each point represents one lecture (the average percentage per slide would be used) for a more holistic view of a lecturer's performance.

FIG. 6 shows an example of a screenshot. This screenshot illustrates the interface used when the time tags and interactive elements are being assigned to the presentation. The emphasis is on the toolbar (20) used within a standard presentation software (16). The presentation software's own toolbar (17) and the taskbar (18) have also been shown. The slides in this particular presentation (19) are shown where the blown up slide on the right is the slide to which a time tag (and interactive element) is being assigned. The layout of the toolbar (20) is such that a time value can be entered and then assigned; there is also another button within the toolbar that is used to assign interactive element from within the text body of the slide. In this case, the interactive element has already been assigned; to the word ‘demonstrating’.

What is claimed is:

1. A method of creating and using computer presentations in a teaching environment that contain timed interactive presentation slides and a system for logging lecture variables, predicting future outcomes and rectifying existing situations.

2. A method for creating timed interactive presentation slides as claimed in 1 in which a Subject. Matter Expert (SME) is provided with an input interface that fits into presentation program software as a toolbar, allowing slides to be assigned time tags for the use in a lecture.

3. The toolbar as claimed in claim 2 wherein the toolbar can be used as either a plugin in available presentation programs or as standalone software for the creation of these timed interactive slides.

4. The time-tags according to claim 2 which can be in any type of programming language and are embedded into the slide.

5. A method for using the timed interactive presentation slides as claimed in claim 1 in which the timed slides will be normally used as teaching material but the proposed software will record the time spent on each slide in a non-obtrusive manner and log these lecture variables in a lecture report.

6. The creation of lecture reports as claimed in claim 5 in which this type of report will be generated after each and every lecture and will be archived in a database stored on the institutes central server.

7. The use of an archive database as claimed in claim 6 wherein all lecture reports will be stored and the database will be used in the creation of performance reports.

8. The creation of performance reports as claimed in claim 7 in which education institute authorities will have a centralized, complete and up to date status report on each and every lecturer that will be dynamically available in real time.

9. The use of performance reports as claimed in claim 8 wherein the report will essentially contain (among others—such as personal details) the current status of every course of a lecturer, the future status of each course (prediction), a method of warning or alerting and a proposed course of action to rectify any situations.

10. The current status fields in a performance report as claimed in claim 9 will contain the progress of the lecturer in a particular course with respect to how much syllabus has been covered and how much time it has taken as a whole.

11. The future status fields in a performance report as claimed in claim 9 wherein artificial neural networks will use many inputs, employ various standard predictive algorithms and produce output, these output will be predictions and extrapolations that indicate how much time it will take to complete a course and how much of a course will be completed by a certain time.

12. The inputs to the artificial neural networks as claimed in claim 11 will be the recorded and archived lecture variables as well as other assessment criteria such as attendance.

13. A method of warning or alerting in a performance report as claimed in claim 9 in which the institute authorities will be informed on the performance of a lecturer by means of indicating progress in the form of the amount of action required to rectify the situation, where ‘no action required’ implies lecturer performance in a particular course is acceptable and so forth.

14. A method of providing a proposed course of action in the performance report as claimed in claim 9 consists of actions that the authorities can take to rectify a situation if needed, these actions are to be carried out by the lecturer to ensure timely and adequate course completion.

15. The interactive element in the interactive timed slides as claimed in claim 1 in which they are created at the time of assigning a time tag to the slide using a toolbar and they are used as a means of assuring a slide (which contains this interactive element) containing an important learning outcome is covered by the lecturer during teaching.

16. The interactive elements according to claim 15 which are distinct words selected by the SME from the text present on the slide; which will be bold and italicised in order to be distinguished and identified among the slide contents.

17. The use of interactive elements as claimed in claim 15 in which a lecturer must stimulate the element by underlining or encircling it during the running of the presentation to show that this learning outcome has been covered.

18. A system for managing the performance of a lecturer as claimed in claim 1 wherein the proposed software can be either installed on an institute's central server or used as a cloud application over the internet, and then used on various teaching devices networked to the central server.
